(19) United States
(12) Patent Application Publication
(10) Pub. No.: US 2006/0056657 A1
(43) Pub. Date: Mar. 16, 2006

(54) Single image sensor positioning method and apparatus in a multiple function vehicle protection control system

(76) Inventors: Joel Hooper, Oxford, MI (US); Joseph J. Spryshak, Hartland, MI (US)

Correspondence Address: Martin J. Jaquez, Esq.;JAQUEZ & ASSOCIATES, Suite 100D, 6265 Greenwich Drive, San Diego, CA, 92122, US

(21) Appl. No.: 11/222,030

(22) Filed: Sep. 7, 2005

Related U.S. Application Data
(63) Continuation-in-part of application No. 10/778,885, filed on Feb. 13, 2004.
(60) Provisional application No. 60/607,889, filed on Sep. 7, 2004.

(51) Int. Cl. G06K 9/00

(52) U.S. Cl. 382/104

(57) ABSTRACT

Single imaging sensor positioning methods and apparatus for use in a vehicle protection system are disclosed. The vehicle protection system employs a single imaging sensor in order to obtain imaging information or imaging data related to a vehicle and its occupants. The vehicle protection system uses the imaging data to condition appropriate deployment of automated vehicle safety and security features and mechanisms. In particular, the imaging sensor is positioned according to a combination of one or more sensor positioning constraints, so as to optimize the usefulness of the imaging data provided by the sensor. In one embodiment, imaging sensor positioning constraints are described with respect to a lateral-vertical (Y-Z) position restriction plane, a fore-aft (X-Z) position restriction plane, and an intersection of the Y-Z and X-Z position restriction planes. In one embodiment, in order to satisfy the single imaging sensor positioning requirements in a multiple function vehicle protection control system, a single imaging sensor should be positioned proximate the passenger side A-Pillar of a vehicle. In this embodiment, an optimum single imaging sensor position is proximate the passenger side A-Pillar, or near the vehicle window frame just aft of the passenger side A-pillar.

### CROSS-REFERENCE TO RELATED APPLICATIONS

This patent application claims the benefit of priority under 35 U.S.C. § 119 (e) to commonly-assigned U.S. Provisional Application No. 60/607,889, filed September 7, 2004, entitled “Improved Single Image Sensor Positioning Method and Apparatus in a Multiple Function Vehicle Protection Control System.” (ATTY DOCKET NO. ETN-025-PROV). Also, this patent application is a Continuation-in-Part (CIP) and claims the benefit under 35 USC § 120 to co-pending and commonly assigned U.S. patent application Ser. No.: 10/778,885, filed Feb. 13^{th}, 2004, entitled “Imaging Sensor Placement in an Airbag Deployment System” (ATTY DOCKET NO. ETN-022-PAP), hereafter “the parent application”. The above-cited provisional application, including both of its appendices, is hereby incorporated by reference herein in its entirety as if set forth in full. The above-cited parent application is also hereby incorporated by reference herein in its entirety as if set forth in full.

### BACKGROUND

1. Field of the Invention

This invention generally relates to imaging sensors for use in vehicle protection systems, and more specifically to methods and apparatus for positioning a single image sensor in multiple function vehicle protection control systems.

2. Related Art

Vehicle protection control systems are commonplace in modern automobiles. As experience with vehicle protection systems has been gained, it has been observed that occupant safety may be enhanced by conditioning protective feature deployment upon information regarding the occupant to be protected. For example, a well-known vehicle protection system is an airbag deployment system. It is widely understood that occupants that are rather small in size and low in weight are better served by suppressing airbag deployment during accidents, or by reducing the rate or force of such airbag deployment during accidents. Even with larger occupants, it is often desirable, under certain driving conditions, to reduce deployment force, or even to preclude airbag deployment entirely, such as when the larger occupant is positioned such that ordinary airbag deployment might cause harm to the occupant.

Threshold criteria for deployment of vehicle protective features may be based on conditions relevant to the vehicle. Such criteria might be provided, for example, when the vehicle is decelerating in a manner that suggests that the safety of an occupant may be in jeopardy. Criteria that are relevant to conditions of the vehicle, as opposed to criteria relevant to conditions specific to an occupant, may thus be used to reach an initial decision pertaining to protective feature deployment. For example, such exclusively vehicle-relevant criteria might also be used to condition airbag deployment. In one example, vehicle-relevant criteria might be used to limit deployment speed or force below a default or selected level.

Modern vehicle protection control systems may also condition deployment of protective features or mechanisms (such as airbags, for example) on information that reflects current conditions of a vehicle occupant. A variety of techniques have been described in the literature for obtaining information about an occupant, upon which such further deployment conditioning may be based. In particular, some techniques “classify” occupants into one of two or more classes, and estimate current occupant position and/or occupant movement. Occupants may be classified, for example, as comprising a “child,” an “adult,” or as being “empty,” and airbag deployment may be conditioned upon such occupant classification by reducing the force of airbag deployment, or precluding airbag deployment altogether, for occupants of one class (e.g., “child”) as compared to occupants of another class (e.g., “adult”). Regarding occupant position and movement, it has been found desirable in some vehicle safety systems to condition airbag deployment (and deployment of other safety and security mechanisms) upon such information, so that an occupant that happens to be too close when an airbag might deploy, for example, is not inadvertently harmed by rapid airbag expansion. The following commonly assigned and co-pending patent applications are hereby incorporated by reference herein in their entirety for their teachings of such vehicle safety systems: U.S. Provisional Application No. 60/581,157 by Farmer, entitled “Improved Vehicle Occupant Classification Method and Apparatus for Use in a Vision-Based Sensing System”, filed Jun. 18, 2004, now U.S. Utility application Ser. No. 11/157,465, by Farmer, entitled “Vehicle Occupant Classification Method and Apparatus for Use in a Vision-Based Sensing System”, filed Jun. 20, 2005 (ATTY. DOCKET NO. ETN-023-PAP), pending; and U.S. Provisional Application No. 60/581,158 by Farmer, et al, entitled “Improved Pattern Recognition Method and Apparatus for Feature Selection and Object Classification”, filed Jun. 18, 2004, now U.S. application Ser. No. 11/157,466, filed Jun. 20, 2005 (ATTY. DOCKET NO. ETN-024-PAP), pending.

In order to obtain information about vehicle occupants, one or more sensors have been used in prior art vehicle safety systems. In particular, imaging sensors have been employed in order to obtain information pertaining to vehicle occupants and vehicle conditions. Various proposals have been set forth in the prior art for enabling a vehicle airbag control system, for example, and for conditioning airbag deployment upon information obtained by the imaging sensors. The following commonly assigned patent applications and issued patents are hereby incorporated by reference herein in their entirety for their teachings in this regard: U.S. patent application Ser. No. 09/901,805, filed Jul. 10, 2001, by Farmer, and entitled “Image Processing System for Dynamic Suppression of Airbags Using Multiple Model Likelihoods to Infer Three Dimensional Information”, published Jan. 23, 2003 as Publication No. 20030016845A1, pending; U.S. patent application Ser. 10/052,152, filed Jan. 17^{th}, 2002, by Farmer, entitled “Image Processing System for Detecting When An Airbag Should Be Deployed”, published Feb. 27, 2003 as Publication No. 20030040859A1, pending; U.S. Pat. No. 6,459,974, issued Oct. 1, 2002 to Baloch, et al., entitled “Rules-Based Occupant Classification System for Airbag Deployment”; and U.S. Pat. No. 6,493,620 issued Dec. 10, 2002 to Zhang, entitled “Motor Vehicle Occupant Detection System Employing Ellipse Shape Models and Bayesian Classification.”

In order for an imaging sensor to derive useful vehicle safety system information about a vehicle occupant, the sensor should be positioned where it can discern sufficient features related to vehicle interiors, including features related to the vehicle occupant. While multiple sensors have been used to acquire information about the vehicle interior, the use of multiple sensors disadvantageously increases the costs and computational complexity associated with the vehicle protection systems. Therefore, it is desirable to use a single imaging sensor, such as a camera, in order to obtain vehicle interior information useful to vehicle protection systems. It is desirable to optimally position a single imaging sensor such that the imaging sensor obtains information sufficient to classify a vehicle occupant, determine the current position and/or movement of the occupant, and obtain other relevant information related to a vehicle. As compared with systems using multiple sensors, a properly positioned single imaging sensor reduces costs and computational complexity associated with vehicle protection systems. The present disclosure teaches novel single imaging sensor positioning methods and apparatus that overcome the disadvantages associated with prior art use of multiple imaging sensors in vehicle protection systems.

### SUMMARY

Methods and apparatus for positioning a single imaging sensor for use with a vehicle protection control system is described. In one embodiment, the single imaging sensor is aligned along an intersection of planes defining an “airbag suppression zone plane” and a “window express disable plane”. The airbag suppression zone plane is defined along an azimuth angle and longitudinal (or lateral-vertical plane) cross vehicle parameters. The window express disable plane is defined in a fore/aft plane parallel with a passenger window. Examples of protective vehicle features include airbag systems, window express disable, theft intrusion detection, and rear-view blind spot monitoring.

In one exemplary embodiment for use in a vehicle protection system that classifies and tracks the movements of vehicle occupants, an optimum imaging sensor position should be aligned approximately directly with the boundary of the airbag suppression zone (in a Y-Z plane). This positioning of the imaging sensor allows the imaging sensor to use its inherent accuracy in its azimuth dimension to provide the distance information between the vehicle occupant and the vehicle instrument panel. In other exemplary embodiments, where the imaging sensor is, for example, adapted to obtain information regarding an image for use in window express disable systems, an optimum imaging sensor position should be within a fore-aft plane (X-Z plane) defining a desired protection zone of a side window. This positioning of the imaging sensor eliminates a need for detecting a third dimension, and allows processing to define a line of pixels as a protection boundary line. In accordance with the present inventive teachings, in one exemplary embodiment, a camera should be positioned proximate an intersection of the two planes defined by these two optimum camera positions. Such a positioning suggests that the imaging sensor be mounted proximate the “A-Pillar”, or proximate a window frame just aft of the A-Pillar, on the passenger's side of the vehicle. In some embodiments, the imaging sensor is generally aimed toward the chest of the vehicle passenger. With this positioning and aiming angle, commonly available wide-angle lenses permit the imaging sensor to capture a field of view that includes almost the entire passenger compartment. Thus, using the disclosed single imaging sensor methods and apparatus, the entire vehicle passenger compartment can be imaged using only a single sensor. Capturing the entire passenger compartment in one image is well suited for use in theft intrusion detection systems, for example, as all points of possible entry into the vehicle interior fall within the image. The cost of vehicle protection systems is reduced using the disclosed imaging sensor positioning methods and apparatus owing to the use of a single imaging sensor.

### BRIEF DESCRIPTION OF THE DRAWINGS

Embodiments of the present disclosure are more readily understood with reference to the following figures, in which like reference numbers and designations indicate like elements.

FIG. 1 illustrates lateral and fore/aft dimensions relative to a vehicle.

FIG. 2 illustrates fore/aft camera placement with respect to an Airbag Suppression Zone (ASZ) for a vehicle interior.

FIG. 3 illustrates dimensions that are relevant for defining an FOV point location.

FIG. 4 illustrates exemplary fore/aft and vertical limitations on image sensor positioning.

FIG. 5 illustrates useful sensor positioning constraints in the Y-Z plane.

FIG. 6 shows proposed image sensor positioning constraints in accordance with the present teachings.

### DETAILED DESCRIPTION

Overview

A vehicle protection control system utilizing an imaging sensor is described. The imaging sensor, which is also referred to herein as an image sensor or “camera”, obtains image information pertaining to a vehicle to be protected. The vehicle image information obtained by the camera or imaging sensor can be used to condition deployment of vehicle protection features and vehicle protection mechanisms under appropriate circumstances. The imaging sensor or camera should be positioned with respect to the vehicle as described below, in order to enhance the information that may be discerned by the sensor. In some cases, positioning as indicated herein permits use of only a single camera which provides all of the necessary vehicle and vehicle occupant data required to appropriately condition deployment of the various vehicle protection features and mechanisms. Information obtained from a properly positioned imaging sensor may, for example, permit the vehicle protection control system to both classify a vehicle occupant in one of a plurality of classification categories relevant to airbag deployment decisions, and to determine position information of the occupant needed to further control airbag deployment decisions.

The disclosed methods and apparatus acquire information about a vehicle. In some embodiments, the vehicle information is subsequently processed by a variety of vehicle protections systems. In some systems, the information is processed using software or firmware executed on a digital signal processor. As used herein, the term “digital processor” is meant generally to include literally any and all types of digital processing devices including, without limitation, digital signal processors (DSPs), reduced instruction set computers (RISC), general-purpose (CISC) processors, microprocessors, and application-specific integrated circuits (ASICs). Such processors may, for example, be contained on a single unitary IC die, or distributed across multiple components. Exemplary DSPs include, for example, the Motorola MSC-8101/8102 “DSP farms”, the Texas Instruments TMS320C6x, Lucent (Agere) DSP16000 series, or Analog Devices 21161 SHARC DSP.

A number of useful constraints on the positioning of a camera or imaging sensor for use by a vehicle protection system are set forth below. In some embodiments, the camera or image sensor position may be constrained within a region defined by a spatial relationship to an “Airbag Suppression Zone (ASZ)”. The camera position may be constrained to a region that is defined with respect to a windshield header (i.e., the border between a windshield and a headliner of the vehicle). In other embodiments, the camera position may also be constrained within a limited range of radii from a “Focus of View” (FOV) point that is defined with respect to typical occupant/seat geometries. Moreover, in some embodiments, the camera position may be precluded from a position within any vertical-fore/aft plane that touches the vehicle occupant, or the occupant's seat. The camera position may be constrained to a region proximate a headliner of the vehicle, and/or to a position permitting an unobstructed line of sight to much or all of a top of the vehicle occupant's window. Also, the camera position may be constrained to a region proximate an A-pillar of a vehicle and proximate the passenger side roofline or headliner. A vehicle protection control system that conditions deployment of a protection feature or mechanism (e.g., an airbag) upon imaging data pertaining to the vehicle and its occupants, as produced by an imaging sensor (e.g., a camera), and that positions the camera according to a combination of one or more of these positioning constraints as described in more detail below, more efficiently and accurately conditions such vehicle protection mechanism deployment.

Unless otherwise noted, positioning of the imaging sensor (camera) is defined with reference to the location of a representative “received image point” (or “image entrance plane center” (“IEPC”) point) of the imaging sensor. The received image point, or IEPC, is defined as the center of the surface, or planar region, through which an image enters the imaging sensor or camera (after which the image is inverted). Thus, if an objective lens is employed, the received image point comprises the center of the outer surface of the objective lens. If focusing is effected by an opening, the received image point is defined as the center of the focusing aperture. In the case of a plurality of image-inverting devices, the received image point is defined as the center of that device upon which incoming light first impinges the device.

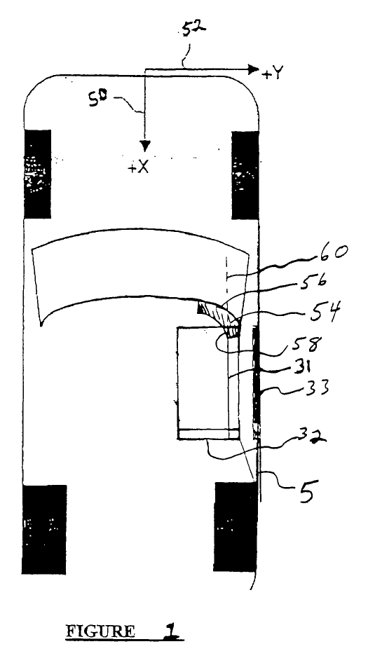

Image sensor positioning is described herein in three dimensions, which are referenced to a vehicle in which the vehicle protection control system is disposed. “X” and “Y” sensor positioning dimensions are illustrated in-FIGURE 1 and are referenced with respect to fore/aft (“X”), lateral (“Y”), and vertical (“Z”) dimensions as described below in more detail. More specifically, in one embodiment, as shown in FIG. 1, the fore/aft or “X” sensor positioning dimension is defined with respect to the front of the vehicle 5. As shown in FIG. 1, a +X axis 50 is defined as increasing in the direction toward the aft, or back, of the vehicle 5. Therefore, as an imaging sensor or camera is positioned closer toward the front of the vehicle, the associated X sensor positioning dimension decreases. As the sensor or camera is positioned closer toward the rear or aft of the vehicle, the associated X sensor positioning dimension increases. A second sensor positioning dimension is referred to as the lateral or “Y” dimension, and is indicated in FIG. 1 by a “+Y” axis 52. As defined herein, the Y sensor positioning dimension increases as the sensor is positioned toward the passenger side (United States passenger) (right side) of the vehicle 5, and decreases as the sensor is positioned toward the driver side (left side of FIG. 1). A third sensor or camera positioning dimension is referred to as the vertical or “Z” dimension, which is increasing in the “out of the paper” direction with respect to FIG. 1, and is orthogonal to both the X and Y axes, 50 and 52, respectively. FIG. 1 is referred to again below with respect to a description of useful limitations that may be imposed upon imaging sensor and camera positioning in the X and Y dimensions.

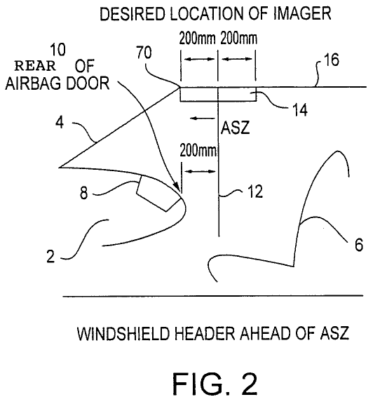

Referring now to FIG. 2, a range of desirable camera locations with respect to an airbag suppression zone (ASZ) is illustrated. As shown in FIG. 2, a dashboard 2 is disposed generally below a windshield 4 and in front of a vehicle seat 6. The dashboard houses an airbag 8. A door in the dashboard 2, through which the airbag expands upon deployment, includes a rearmost (or “aft-most”) portion 10. Due to the nearly explosive force with which the airbag can be deployed, it is widely considered useful to define an airbag suppression zone (ASZ), within which occupant safety might be jeopardized by full-speed deployment of the airbag. Accordingly, if the airbag is otherwise to be deployed, deployment can be modified or suppressed when it is determined that the occupant is intruding into the ASZ. The exact volume and shape of the ASZ may be determined empirically, and may depend upon a variety of factors, such as, for example, the airbag position within the vehicle, the airbag deployment direction, and the maximum airbag deployment speed. In the exemplary embodiment shown in FIG. 2, the ASZ is indicated by an approximately vertical line 12. The ASZ line 12 represents a Y-Z plane (i.e., a lateral/vertical plane) that is coincident with the rearmost (or aft-most) extent of the ASZ. For the particular embodiment illustrated in FIG. 2, the ASZ occupies the entire volume of the vehicle interior that is forward of a plane represented by the line 12. The plane represented by the ASZ line 12 is the rearmost Y-Z plane of the ASZ, and is in the illustrated embodiment, approximately 200 mm aft of the rearmost portion 10 of the airbag deployment door.

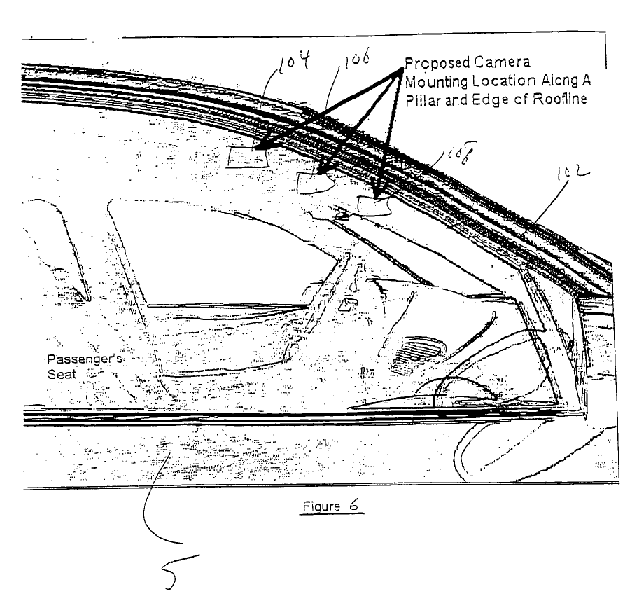

As shown in FIG. 2, in an embodiment wherein airbag deployment is the primary vehicle protection feature or mechanism, a camera or other imaging sensor positioning region 14 is positioned generally proximate a headliner 16 of the vehicle. The camera or image sensor may be restricted to the region 14, which extends approximately 200 mm fore and approximately 200 mm aft of the intersection of the ASZ line 12 and the headliner 16. In some embodiments, the vertical imaging sensor location region may also be restricted to be within 50, 75 or 100 mm of the headliner 16. As described below in more detail with reference to FIG. 6, one such embodiment includes positioning the sensor proximate one of the vehicle's “A-pillars”. As is well known most vehicles have two A-Pillars, one on each side of the front windshield. The A-pillars support the roof of the vehicle and are typically located in front of the driver (i.e., they are located on both sides of the front windshield).

As described in the above-incorporated pending parent patent application and specifically with reference to FIG. 2 of the incorporated parent application, in other embodiments, the ASZ rearmost Y-Z plane, represented by the ASZ line 12 (shown in FIG. 2 of the present application), does not intersect with the vehicle headliner 16 (as it does in FIG. 2 of the present application). In these embodiments, the ASZ plane (line 12) does not intersect with the headliner 16 because the windshield header 70 (where the windshield 4 meets the vehicle header 16) is located aft of the ASZ plane (as opposed to being located forward of the ASZ plane as shown in FIG. 2 of the present application). As described in the above-incorporated parent patent application, in these embodiments, it may be physically impractical to restrict the imaging sensor location to a position within 200 mm fore or aft of the ASZ plane. As such, in these embodiments, an alternative imaging sensor position may be restricted to be within approximately 200 mm aft of the windshield header 70, though it may still be limited to a position within approximately 50, 75 or 100 mm of the vehicle headliner 16 in various embodiments.

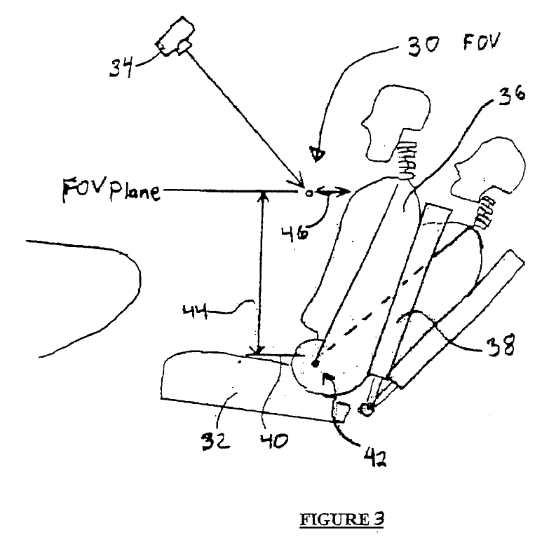

Referring now to FIG. 3, an exemplary location of a Focus of View (FOV) point 30 for an occupant seat 32 is illustrated. Wherever positioned, as defined by its received image point or IEPC, the imaging sensor or camera 34 is aligned so that the FOV point is approximately centered within its field of view. That is, the imaging sensor or camera 34 should be “aimed” at the FOV point 30. In some embodiments, the imaging sensor or camera is positioned such that the FOV point 30 comprises the approximate center of the field of view of the imaging sensor or camera.

In the illustrated embodiment, the FOV point 30 should be positioned a short distance in front of a model 36 representing a nominal occupant of an occupant seat 32 that is centered within its fore/aft range of adjustment. The FOV point 30 is also in a vertical-fore/aft plane that passes through the center of the model 36. In one embodiment, the model 36 is an anthropomorphic dummy of a “95th percentile” male, such as is commonly used in automotive safety and ergonomics testing. Details of the 95th percentile model for such an embodiment are defined in PART 571 of the Federal Motor Vehicle Safety Standards on CRASHWORTHINESS, Standard No. 208—Occupant Crash Protection (also 49 CFR 571.208, Code of Federal Regulations Title 49, Volume 5, Revised as of Oct. 1, 2003, Pages 492-571), which is hereby incorporated herein in its entirety by reference. In accordance with the present disclosed method and apparatus, the model 36 is positioned in the vehicle seat 32. The seat 32 is centered in its fore/aft adjustment range. If the seat 32 has an adjustable elevation, it may also be centered in its vertical adjustment range. A seatback 38 of the seat 32 is tilted to an angle that approximates an expected seatback angle, an angle frequently referred to in the art as the “design angle” of the seat back.

In one embodiment, a base vertical reference (VR) level 40 is used to locate the FOV point 30. In one embodiment, the VR level 40 comprises a horizontal plane (i.e., a plane having constant vertical dimension) that passes through a hip pivot point 42 of the occupant model. The hip pivot point 42 is typically referred to in the vehicle occupant safety art as the “H” point of the model 36. In another embodiment, the VR level 40 comprises a horizontal plane that is tangent to the seat that is to be protected. In accordance with the present disclosed method and apparatus, the FOV point 30 is located in a horizontal plane that is a selected distance, as indicated in FIG. 3 by a line 44, above the VR level 40. In one embodiment, the FOV point 30 is located in a horizontal FOV plane positioned approximately 442 mm above the VR level 40. In other embodiments the FOV plane may be positioned approximately 442 mm±20 mm above the VR level 40. In other embodiments, the distance between the FOV and VR planes (as indicated by the line 44) may be approximately 400 mm, approximately 420 mm, approximately 470 mm, or approximately 500 mm. The most desirable distance may depend, for example, upon the range of body sizes of the occupants for which image information is intended to be used to condition deployment of the vehicle protection features. The desirable value will also depend upon how the VR level 40 is defined.

In addition to being positioned in a particular horizontal plane as described above, in one embodiment, the FOV point 30 is centered on the model, i.e., it is positioned at a position that matches the center of the model 36. The FOV point 30 is positioned a selected distance away from and forward of the “chest” of the model 36, as indicated in FIG. 3 by a line 46. In one embodiment, the model 36 represents a 95^{th} percentile male occupant, as described above, and the model 36 is positioned as described above, and the FOV point is approximately 75 mm forward from the chest of the model 36. In other embodiments, the FOV point 30 may be 75±20 mm in front of the model 36, or it may be 25 mm, 50 mm, or 100 mm forward of the chest of the model 36.

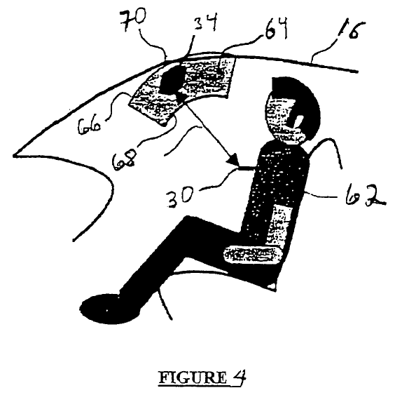

FIG. 4 illustrates useful sensor positioning range limits for the camera or imaging sensor 34 in the X and Z sensor positioning dimensions. In one embodiment, as shown in FIG. 4, the camera or imaging sensor 34 may be constrained to be positioned generally within a region 64 between a maximum radius 66 and a minimum radius 68 from the FOV point 30. Of course, this constraint may be in addition to fore/aft constraints with respect to a windshield header 70, and to vertical or Z dimension constraints with respect to the vehicle headliner 16, as described above with reference to FIGS. 2 and 3.

Returning again to FIG. 1, some positioning limitations are illustrated therein that, in accordance with some embodiments of the present invention, usefully restrict the positioning of the sensor 34 in the X and Y sensor positioning dimensions. In particular, the sensor 34 (as defined by its received image point or IEPC described above) may be constrained to be positioned within a shaded region 54. As shown in FIG. 1, the shaded region 54 is disposed, in one embodiment, between an outer (i.e., closer toward the vehicle exterior) curve 56, reflecting a maximum radius from the FOV point, and an inner (i.e., closer toward the vehicle interior) curve 58, representing a minimum radius from the FOV point. The shaded region 54 may be further constrained, as shown, to a region that is proximate the vehicle headliner 16, as described above with respect to FIGS. 2-4.

FIG. 1 also illustrates a lateral (Y dimension) limitation that may be imposed upon the positioning of the image sensor 34. In some embodiments, the lateral (Y dimension) position of the image sensor 34 may be constrained to ensure that the sensor's 34 view of a driver and other interior portions of the vehicle are not obstructed by a passenger or other objects. Stated more precisely, in some embodiments, the imaging sensor 34 may be precluded from being positioned in any vertical fore/aft plane (X-Z plane) that passes through the passenger seat 32, of that results in the obstruction of the sensor's 34 view of a driver and other interior portions of the vehicle. To define this lateral positioning constraint more specifically, in one embodiment, an X-Z edge plane 60 is defined wherein the edge plane 60 (shown as a dotted line in FIG. 1) comprises an X-Z plane that is parallel to and proximate an edge 31 of the passenger seat 32. The imaging sensor 34 may be required to be positioned opposite from a passenger occupant (i.e., an occupant sitting in the passenger seat 32) with respect to the X-Z edge plane 60. In some embodiments, the edge plane 60 passes through the edge 31 of the seat 32 on a side closest to the image sensor position. However, in some situations, such as in vehicles having bench seats, the edge of the physical seat 32 may not reflect expected positions of the occupant. Therefore, the edge plane 60 may be defined differently in accordance with particular vehicle geometries. For example, the edge plane 60 may be defined by the expected lateral range of the passenger occupant.

Referring again to FIG. 1, and defining this lateral image sensor positioning restriction more specifically, the edge plane 60 can be defined as comprising an X-Z plane that passes through the edge 31 of the passenger seat 32 on a side closest to the passenger door 33 (i.e., the right-most edge of the passenger seat 32 shown in FIG. 1). In one embodiment, in order to enhance the usefulness of the single image sensor 34 for use in protective automotive systems, and in accordance with the present teachings, the image sensor 34 is laterally constrained to be positioned along an X-Z plane that is parallel to the passenger door 33 and that is opposite the seat 32 occupant with respect to the edge plane 60. This lateral positioning constraint ensures that the sensor's 34 view of the driver and interior of the vehicle will not be blocked by the passenger's body as the passenger moves in the passenger seat 32.

In one embodiment, in order to allow the image sensor 34 to obtain images for use in a “window express disable” system, for example, the image sensor 34 is positioned within an X-Z plane corresponding to a desired protection zone of the side window. As is well known in the automotive arts, a window express system automatically fully opens or closes a window upon a single touch command initiated by a vehicle occupant (an “up” or “down” window express command, typically initiated when an occupant quickly depresses an electronic switch, thereby triggering the automatic full opening or closing of a window). In a window express disable system, the system immediately stops the full closure of a window when an object is detected as protruding through the window. Because a passenger may have an arm or other object protruding through the X-Z plane of the window during a window express closure, the window express closure may disadvantageously damage or injure such an object or person. In this embodiment, the window express disable feature employs the imaging information obtained by the sensor 34 to determine whether there is an object protruding through the X-Z plane corresponding to the desired protection zone, and automatically disables the window from closing completely.

For example, if a passenger has an arm extending through the X-Z plane corresponding to the desired protection zone defined for the passenger window, the sensor 34 should be laterally positioned to capture this information, and automatically disable the window express feature, until such a time as there is no longer an object extending into the desired protection zone. Positioning the sensor 34 in this manner eliminates a need to discern the location of objects in a “third dimension”. That is, an image processor that is operatively coupled to the sensor 34 merely has to determine whether an object is on one side or the other of the X-Z plane corresponding to the desired protection zone associated with the window. In one embodiment, this is accomplished by defining the X-Z plane corresponding to the desired protection zone of a window as a two-dimensional window express disable boundary line. Objects that are on one side of the two-dimensional window express disable boundary line (i.e., closer to the window and at risk of being injured) will trigger the window express disable mechanism. Objects that are on the other side of the window express disable boundary line (i.e., further away from the window and thereby not at risk of being injured) will not trigger the window express disable mechanism.

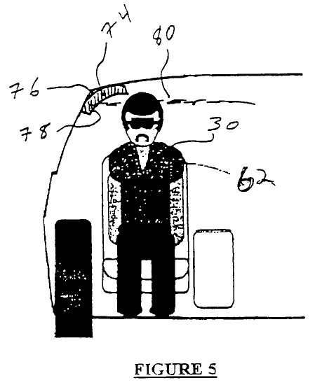

As described in more detail in the parent patent application, FIG. 5 illustrates useful sensor positioning range limits in a Y-Z plane. As shown in FIG. 5, the positioning of the sensor, as defined by the image-entrance point, may be constrained to be within a region 74 that is located between a maximum radius 76 and a minimum radius 78 from the FOV point 30. To help ensure that the entire head of the occupant is within the field of view of the sensor throughout the typical range of motion of the occupant 62, the sensor may be further constrained to be positioned within a line of sight (i.e., have an unobstructed view) of all, or a significant portion, of the top of the occupant's associated window (as indicated in FIG. 5 by a dotted arrow 80). Of course, this requirement may not only limit the Y and Z dimensions shown in FIG. 5, but it may also limit an X dimension of the sensor position.

In some vehicle protection control systems, several value-added vehicle protection features and mechanisms may be available for use with optics-based sensors that collect images for further electronic processing. Some of these protection features and mechanisms include Airbag Suppression Systems for performing dynamic suppression of airbags using a single camera, window express disable for use in protecting objects in the window opening when the window is being closed, and vehicle theft or intrusion detection and alarm features for detecting unauthorized intrusion by a thief and for initiating an alarm should a thief intrusion be detected. One embodiment of this invention defines an optimum imaging sensor positioning whereby a single imaging sensor is positioned within a vehicle in order to obtain imaging data relating to the vehicle that can be used in all of these applications, and has the most potential for use in future vehicle protection features and mechanisms, such as, for example, rear-view mirror blind spot monitoring.

As described in the above-incorporated parent application, there have been multiple proposed systems using cameras and additional sensors for successfully classifying an automotive occupant and also for tracking occupant motion within the vehicle. As described in the incorporated parent application, a first optimum position of the imaging sensor may be restricted along a lateral-vertical (Y-Z) position restriction plane that facilitates suppression of airbag deployment. For example, as described above, a first optimum position (with respect to the IEPC of the imaging sensor) of a single imaging sensor used in classifying and tracking vehicle occupants is in approximate direct alignment with the rearmost (or aft-most) boundary of the ASZ (as shown by the ASZ line 12 in FIG. 2). Restricting the position of the sensor within a lateral-vertical (Y-Z) position restriction plane that is approximately directly aligned with the rearmost ASZ boundary (i.e., approximately parallel to and proximate the aft-most ASZ boundary) allows the sensor to use its inherent accuracy in its azimuth dimension to provide distance information between a vehicle occupant and the rearmost ASZ boundary. This positioning of the sensor places the sensor in a “cross car” vertical position restriction plane (or lateral-vertical, Y-Z plane) that is approximately slightly aft of the rearmost point of the passenger side instrument panel and the rearmost ASZ boundary.

For example, as described in the incorporated parent application, and as described above with reference to FIG. 2, in one embodiment, the first optimum position of the single imaging sensor falls within the region 14. As described above, region 14 extends (in the X dimension) approximately 200 mm fore and approximately 200 mm aft of the intersection of the ASZ line 12 (the rearmost ASZ Y-Z plane boundary) and the vehicle headliner 16. Also, as described above, in some embodiments where the Y-Z plane defined by the aft-most ASZ boundary (represented by the ASZ line 12 in FIG. 2) does not intersect with the vehicle headliner 16 (because the windshield header 70 is aft of the rearmost ASZ boundary), it may be physically impractical to position the imaging sensor 200 mm fore or aft the rearmost ASZ boundary. In these embodiments, the first optimum position of the imaging sensor may be restricted to be within approximately 200 mm aft of the windshield header 70 (i.e., where the windshield 4 meets the headliner 16). In both of the above-described embodiments, the imaging sensor may also be vertically restricted to be positioned proximate the vehicle headliner 16, as described above with reference to FIG. 2.

As described above with reference to FIG. 1, in order to position a single imaging sensor for use in a window express disable system, the sensor may be optimally positioned (with respect to the IEPC) within a fore-aft position restriction plane (i.e., an X-Z plane) that defines the desired protection zone of the side window. Stated in other terms, a second optimum position of the imaging sensor may be restricted along an X-Z position restriction plane corresponding to the desired protection zone associated with the side window. In vehicle systems equipped with window express disable systems, in one embodiment, the X-Z position restriction plane corresponding to the desired protection zone comprises a two-dimensional window express disable boundary. As described above, this second optimum position eliminates a need for processing in a third dimension and allows an image processor to define a two-dimensional line of pixels (i.e., the line formed by the X-Z plane defining the window express disable boundary) which defines the boundary separating an object that is not endangered by a window express command and an object that is endangered during the execution of such a command.

Also, as described above with respect to FIG. 1, a second optimum position of the imaging sensor can be restricted to fall within an X-Z position restriction plane that ensures that the sensor's view of the driver and other interior portions of the vehicle are not obstructed by a passenger occupant or other objects. As described above with reference to FIG. 1, in some embodiments, the imaging sensor is laterally constrained to be positioned along an X-Z position restriction plane that is parallel to the passenger door and that is opposite the passenger occupant with respect to an X-Z edge plane.

In order to satisfy the above two optimum imaging sensor position requirements, and in accordance with the present teachings, in one embodiment, the single imaging sensor should be positioned proximate an intersection of the two position restriction planes defined by these two optimum positioning requirements. More specifically, as described above, the first optimum position dictates that the sensor position fall within a lateral-vertical (Y-Z) position restriction plane (i.e., positioned proximate the rearmost ASZ Y-Z plane as described above). The second optimum position dictates that the sensor position fall within a fore-aft vertical (X-Z) position restriction plane (e.g., defined in some embodiments by the window express disable X-Z plane or defined by the X-Z plane that is parallel to the passenger door and opposite the seat occupant with respect to the edge plane). In order to satisfy the above-described first and second optimum position requirements with one imaging sensor, the imaging sensor should be positioned proximate the intersection of the above-described X-Z and Y-Z position restriction planes.

Such proposed sensor positioning constraints are shown in FIG. 6. As shown in FIG. 6, in some embodiments, the intersection of the X-Z and Y-Z position restriction planes is located proximate a passenger side A-Pillar. Referring to FIG. 6, in order to satisfy the sensor positioning requirements when a single imaging sensor is used in a multiple function vehicle protection control system, the sensor may be positioned proximate the passenger side A-Pillar 102 of the vehicle 5. In other embodiments, the imaging sensor 34 may be positioned proximate the window frame just aft of the passenger side A-Pillar 102. FIG. 6 shows three possible single imaging sensor positioning locations, 104, 106 and 108. As shown in FIG. 6, the optimum single imaging sensor positioning locations are approximately proximate the passenger side A-Pillar 102, or near the vehicle window frame just aft of the passenger side A-pillar 102. The sensor is typically aimed, in general, as described above, in a direction towards the chest of the passenger side occupant. With this positioning and aiming angle, widely available wide-angle lenses allow the sensor to capture a field of view that includes almost the entire passenger compartment. Capturing the entire passenger compartment in one image is ideal for use in theft intrusion detection, as all points of possible entry are displayed within the image. As described above, using a single imaging sensor reduces the costs associated with the vehicle protection system as compared with systems that use multiple cameras.

In one embodiment of the invention, the imaging sensor may be oriented according to the aforementioned sensor positional constraints, such that portions of a vehicle interior potentially subject to a thief-induced entry are within a field of view of the sensor. Such portions of a vehicle include, inter alia, windows, doors, hatchback, and sunroof. The sensor captures imaging information (also referred to herein as imaging data) associated with an unauthorized vehicle entry and provides this information to the vehicle safety control system. The system automatically selects a security mechanism to counter the entry, using a type well known to those of ordinary skill in the art, such as a vehicle alarm. In one embodiment, an alarm may transmit intruder information via an on-board transceiver to a vehicle owner, police or other security force. Alternative vehicle security mechanisms include taking a photographic image of the thief and transmitting such information via an on-board communications transceiver, such as General Motor's “On-Star™” system.

In one embodiment of the disclosed method and apparatus, the imaging sensor may be oriented according to the above-described sensor position constraints, such that a rear-view mirror blind-spot may fall within the field of view of the sensor. In this embodiment, the vehicle blind-spot may be monitored thereby enhancing the performance of the automated vehicle safety mechanisms, such as the deployment of airbags.

### CONCLUSION

The foregoing description illustrates exemplary implementations, and novel features, of aspects of a vehicle protection control system that utilizes a single imaging sensor to obtain information about a vehicle interior for purposes of conditioning deployment of vehicle protection features and mechanisms. The description focuses upon desirable positioning of the single imaging sensor and a system for utilizing such images to condition deployment of vehicle protection systems and mechanisms. In general, other aspects of the protection deployment system may be selected as desired for particular vehicles.

Those skilled in the art will appreciate that the disclosed method and apparatus may be practiced or implemented in any convenient computer system configuration, including hand-held devices, multiprocessor systems, microprocessor-based or programmable consumer electronics, network PC's, minicomputers, mainframe computers, and the like. The disclosed methods and apparatus may also be practiced or implemented in distributed computing environments where tasks are performed by remote processing devices that are linked through a communications network. In a distributed computing environment, program modules may be located in both local and remote memory storage devices.

The skilled person will understand that various omissions, substitutions, permutations, and changes in the form and details of the illustrated methods and apparatus may be made without departing from the spirit or scope of the disclosed methods and apparatus. It is impractical to list all embodiments explicitly. As such, each practical combination of camera positioning constraints set forth above, or shown in the attached figures, or described in the following claims, together with each practical combination of equivalents of such positioning constraints, constitutes a distinct alternative embodiment of the disclosed method and apparatus. Due to the impracticality of exhaustively setting forth each possible embodiment, the scope of the disclosed method and apparatus should be determined only by reference to the appended claims, and is not to be construed as limited by any particular features described in the foregoing description except insofar as such limitation is recited in an appended claim.

All variations coming within the meaning and range of equivalency of the various claim elements are embraced within the scope of the corresponding claim. Each claim set forth below is intended to encompass any system, apparatus or method that differs only insubstantially from the literal language of such claim, as long as such system or method is not, in fact, an embodiment of the prior art. To this end, each described element in each claim should be construed as broadly as possible, and moreover should be understood to encompass any equivalent to such element insofar as possible without also encompassing the prior art.

What is claimed is:

1. A method of positioning a single imaging sensor in a vehicle for use with a multiple function vehicle protection control system, wherein the imaging sensor includes an image entrance plane center (IEPC) and wherein sensor positioning is defined with reference to the IEPC, and wherein the sensor is aimed at a focus of view (FOV) point defined for the vehicle with respect to an expected typical vehicle occupant position and typical vehicle seat geometry, and wherein the IEPC is positioned a selected distance from the FOV point, and wherein the sensor positioning is further defined with reference to fore-aft (X dimension), lateral (Y dimension) and vertical (Z dimension) dimensions associated with the vehicle, comprising:
(a) determining a lateral-vertical (Y-Z) position restriction plane, wherein the sensor positioning is restricted to fall approximately within the Y-Z position restriction plane;
(b) determining a fore-aft (X-Z) position restriction plane, wherein the sensor positioning is restricted to fall approximately within the X-Z position restriction plane;
(c) determining an intersection of the Y-Z and X-Z position restriction planes determined in steps (a) and (b); and
(d) positioning the single imaging sensor proximate the intersection determined in step (c).

2. The positioning method of claim 1, wherein the step (a) of determining the Y-Z position restriction plane comprises determining an aft-most boundary of an Airbag Suppression Zone (ASZ), and aligning the Y-Z position restriction plane with the aft-most ASZ boundary such that the Y-Z position restriction plane is approximately parallel to and proximate the aft-most ASZ boundary.

3. The positioning method of claim 2, wherein the ASZ is defined as a suppression zone for a vehicle airbag having a longitudinal extent between suppression zone maximum and minimum longitudinal references of the vehicle.

4. The positioning method of claim 3, wherein the Y-Z position restriction plane is disposed within approximately 200 mm of the aft-most ASZ boundary.

5. The positioning method of claim 3, wherein the Y-Z position restriction plane is disposed within approximately 200 mm aft of a windshield header of the vehicle when the windshield header is located further aft than the aft-most ASZ boundary.

6. The positioning method of claim 1, wherein the step (b) of determining the X-Z position restriction plane includes precluding the imaging sensor from being positioned in an X-Z plane passing through a passenger seat of the vehicle.

7. The positioning method of claim 1, wherein the step (b) of determining the X-Z position restriction plane includes ensuring that the imaging sensor is positioned in an X-Z plane that affords an adequate view of a driver of the vehicle and of other objects within an interior of the vehicle.

8. The positioning method of claim 1, wherein the step (b) of determining the X-Z position restriction plane comprises:
(e) determining a lateral edge of a vehicle passenger seat wherein the lateral edge is located on a side of the passenger seat that is closest to a passenger side door of the vehicle;
(f) defining an X-Z edge plane that passes through and is parallel to the lateral edge determined in step (e); and
(g) disposing the X-Z position restriction plane approximately adjacent to the X-Z edge plane defined in step (f), wherein the X-Z position restriction plane is approximately parallel to the passenger side door, and wherein the X-Z position restriction plane is disposed on a side of the X-Z edge plane that is opposite from an occupant of the passenger seat.

9. The positioning method of claim 8, wherein the X-Z edge plane is defined with reference to expected lateral movements of the passenger occupant.

10. The positioning method of claim 9, wherein the lateral movements of the passenger occupant are periodically sampled, and wherein the X-Z edge plane is dynamically updated responsive to the sampled lateral movements of the passenger occupant.

11. The positioning method of claim 1, wherein the step (b) of determining the X-Z position restriction plane includes determining a desired side window protection zone located proximate a side window of the vehicle, and wherein the side window protection zone is defined such that any objects entering the zone are detected and prevented from potential injury by operation of the side window.

12. The positioning method of claim 11, wherein the side window comprises a passenger side window, and wherein the side window protection zone is defined by an X-Z plane that is positioned a selected short distance away from the passenger side window and is approximately parallel to the passenger side window.

13. The positioning method of claim 12, wherein the X-Z position restriction plane corresponds to the side window protection zone as defined by the X-Z plane.

14. The positioning method of claim 13, wherein the vehicle protection control system includes a window express disable system, and wherein the X-Z position restriction plane corresponds to a window express disable boundary.

15. The positioning method of claim 14, wherein the window express disable boundary comprises a boundary separating an object that is not endangered by a window express command from an object that is endangered during execution of the window express command.

16. The positioning method of claim 15, wherein the window express disable system determines whether an object is within or outside of the side window protection zone, and wherein the window express disable system disables an express window command if the object is detected within the side window protection zone.

17. The positioning method of claim 16, wherein the window express disable system determines whether an object is located within the side window protection zone by determining whether the object is closer to the passenger side window than is the X-Z position restriction plane.

18. The positioning method of claim 1, wherein the intersection between the Y-Z and X-Z position restriction planes comprises a sensor positioning region that is proximate an A-Pillar of the vehicle.

19. The positioning method of claim 1, wherein the intersection between the Y-Z and X-Z position restriction planes comprises a sensor positioning region that is proximate a passenger side A-Pillar of the vehicle.

20. The positioning method of claim 19, wherein the sensor positioning region is proximate a vehicle window frame that is located slightly aft the passenger side A-Pillar.

21. The positioning method of claim 19, wherein the sensor positioning region includes a plurality of imaging sensor positioning locations for positioning the imaging sensor.

22. The positioning method of claim 21, wherein the sensor is aimed at an FOV point defined for the vehicle with respect to an expected typical vehicle passenger occupant position and typical passenger seat geometry.

23. The positioning method of claim 1, wherein the positioning of the single imaging sensor in step (d) enables the single imaging sensor to provide imaging information regarding an interior of the vehicle and vehicle occupant information to the vehicle protection control system, and wherein the vehicle protection control system monitors the imaging information provided by the imaging sensor when controlling deployment of vehicle protection features and mechanisms.

24. The positioning method of claim 23, wherein the imaging sensor is positioned in step (d) such that a rear-view mirror blind spot of the vehicle falls within a field of view of the imaging sensor, and wherein the vehicle protection control system monitors the rear-view mirror blind spot when controlling deployment of vehicle protection features and mechanisms.

25. The positioning method of claim 23, wherein the vehicle protection features include a vehicle airbag.

26. The positioning method of claim 23, wherein the vehicle protection features include a vehicle window express disable feature.

27. The positioning method of claim 23, wherein the vehicle protection features include a vehicle theft detection and alarm feature, and wherein the positioning of the single imaging sensor in step (d) ensures that portions of the vehicle interior potentially subject to a thief-induced entry fall within a field of view of the imaging sensor.

28. The positioning method of claim 27, wherein the vehicle protection control system deploys a vehicle alarm if a theft or unauthorized intrusion of the vehicle is detected by the theft detection feature.

29. A single imaging sensor positioning apparatus positioning a single imaging sensor in a vehicle for use with a multiple function vehicle protection control system, wherein the imaging sensor includes an image entrance plane center (IEPC) and wherein sensor positioning is defined with reference to the IEPC, and wherein the sensor is aimed at a focus of view (FOV) point defined for the vehicle with respect to an expected typical vehicle occupant position and typical vehicle seat geometry, and wherein the IEPC is positioned a selected distance from the FOV point, and wherein the sensor positioning is further defined with reference to fore-aft (X dimension), lateral (Y dimension) and vertical (Z dimension) dimensions associated with the vehicle, comprising:
(a) means, in operative communication with the imaging sensor, for determining a lateral-vertical (Y-Z) position restriction plane, wherein the sensor positioning is restricted to fall approximately within the Y-Z position restriction plane;
(b) means, in operative communication with the imaging sensor, for determining a fore-aft (X-Z) position restriction plane, wherein the sensor positioning is restricted to fall approximately within the X-Z position restriction plane;
(c) means, responsive to the Y-Z position restriction plane determining means and the X-Z position restriction plane determining means, for determining an intersection of the Y-Z and X-Z position restriction planes; and
(d) means, responsive to the intersection determining means, for positioning the single imaging sensor proximate the intersection.

30. A computer program executable on a general purpose computing device, wherein the program determines positioning of a single imaging sensor in a vehicle for use with a multiple function vehicle protection control system, and wherein the imaging sensor includes an image entrance plane center (IEPC) and wherein sensor positioning is defined with reference to the IEPC, and wherein the sensor is aimed at a focus of view (FOV) point defined for the vehicle with respect to an expected typical vehicle occupant position and typical vehicle seat geometry, and wherein the IEPC is positioned a selected distance from the FOV point, and wherein the sensor positioning determined by the computer program is further defined with reference to fore-aft (X dimension), lateral (Y dimension) and vertical (Z dimension) dimensions associated with the vehicle, comprising:
(a) a first set of instructions determining a lateral-vertical (Y-Z) position restriction plane, wherein the sensor positioning is restricted to fall approximately within the Y-Z position restriction plane;
(b) a second set of instructions determining a fore-aft (X-Z) position restriction plane, wherein the sensor positioning is restricted to fall approximately within the X-Z position restriction plane;
(c) a third set of instructions, responsive to the first and second instruction sets, determining an intersection of the Y-Z and X-Z position restriction planes; and
(d) a fourth set of instructions, responsive to the third instruction set, positioning the single imaging sensor proximate the intersection of the Y-Z and X-Z position restriction planes.

31. A vehicle imaging system obtaining imaging data for use in controlling deployment of vehicle protection features in a vehicle, comprising:
(a) a single imaging sensor adapted to obtain the imaging data, wherein the imaging data relates to both the vehicle and to occupants of the vehicle, and wherein the imaging sensor is positioned with respect to the vehicle in accordance with the method set forth in claim 1;
(b) an image processor, operatively coupled to the single imaging sensor, configured to determine information pertaining to the vehicle and the vehicle occupants based upon the imaging data obtained by the imaging sensor;
(c) a multiple function vehicle protection control system, operatively coupled to the image processor, wherein the vehicle protection control system controls deployment of one or more vehicle protection features responsive to the information determined by the image processor; and
(d) at least one vehicle protection feature deployment mechanism, operatively coupled to the multiple function vehicle protection control system, wherein the at least one vehicle protection feature deployment mechanism conditionally deploys a selected vehicle protection feature responsive to the vehicle protection control system.
